(19) United States
(12) Patent Application Publication
(10) Pub. No.: US 2026/0187474 A1
(43) Pub. Date: Jul. 2, 2026

(54) SPECIFICITY AWARE TEACHER MODEL AND STUDENT MODEL BASED ON LARGE LANGUAGE MODEL

(71) Applicant: Google LLC, Mountain View, CA (US)

(72) Inventors: Kaung Mon Khin, Mountain View, CA (US); Daniel William Fitzick, Sunnyvale, CA (US); Yi Sun, San Mateo, CA (US)

(21) Appl. No.: 18/859,413

(22) PCT Filed: Aug. 17, 2023
(86) PCT No.: PCT/US2023/030477

§ 371 Date: Oct. 23, 2024

(51) Int. Cl. G06N 3/096

(52) U.S. Cl. CPC G06N 3/096

(57) ABSTRACT

Methods, systems, and apparatus, including computer programs encoded on a computer storage medium, for using a large language model (LLM) to generate a specificity labeled query-to-document scored teacher training set for training a teacher model. The teacher model, in turn, in sued to generate a specificity labeled query-to-document scored student training set for training a student model. The student model is ensemble trained, using the student model specificity training set and at least one other student model training set does not quantify the query-to-landing page specificity drift, to predict a performance of a query for a landing page.

### BACKGROUND

This specification relates to data processing and, in particular, the use of a large language model and distillation to generate specificity aware student models.

Digital components, which are discrete units of digital content or digital information, are selected for inclusion with digital content that is served to a requesting user device. To select the digital components to be served, a system needs to be able to evaluate which digital components would be best to serve for a particular serving instance. One way of selecting a digital component is by use matching queries to landing pages associated with the digital component.

Systems can predict, based on various modeling techniques, whether a query is “related” to a landing page. As used in this specification, the determination of whether a query is related to a landing page is based, in part, on how likely a landing page is to satisfy a user's informational need of a user that issued the query to an information processing system. Such a determination can be based on traffic logs, semantic analysis of the query and the landing page, and other factors.

However, for a given query and landing page pair that are determined to be related, the specificity of the landing page and the specificity of the query may have a significant impact on the performance of the query and landing page pair. For instance, the query “recyclable bags” can refer to many kinds of bags (grocery bags, trash bags, resealable bags, etc.) and thus, is much more generic than a particular landing page. On the other hand, the query “clear recyclable resealable bags” is at about similar specificity as many particular landing pages, and the query “4×4 clear recyclable resealable plastic bags” is often more specific than a particular landing page.

Existing models, however, have difficultly predicting whether the query is more generic, more specific, or about the same specificity as the landing page. Because existing models are not able to distinguish specificity, the models tend to generate an increase in the generic query-to-specific landing page matches. This results in an overserving of digital components, which, in turn, results in system inefficiencies.

### SUMMARY

In general, one innovative aspect of the subject matter described in this specification can be embodied in methods that include the actions of: for each of a plurality of query and landing page pairs, each query and landing page pair being a particular query and a particular landing page selected for the query: obtaining, for the query, a proper subset of search results responsive to the query, the proper subset of search results being search results that are ranked higher than other search results in a set of search results determined to be responsive to the query, wherein each search result links to a search result page; for each search result page and the landing page: generating, by a large language model trained to determine a label probability, a plurality of label probabilities, each label probability generated for a particular label in a set of labels and generated by a separate inference call of the large language model, determining, from the plurality of label probabilities, a document-to-document score that is a quantification of a specificity of the landing page relative to a specificity of the search result page, and determining, from the document-to-document scores, a query-to-document score that quantifies a query-to-landing page specificity drift; storing, in a teacher model specificity training set, training tuples, each training tuple being a query and landing page pair and the query-to-document score determined for the query and landing page pair; and training a teacher model on the teacher model training set to determine, for an input of a query and a landing page selected for the query, a query-to-document score, wherein the query-to-document score is determined without search results and search result pages determined to be responsive to the query. The features above can also be embodied in systems and non-transitory computer storage media.

These and other embodiments can each optionally include one or more of the following aspects. In an aspect, the method includes processing, using the teacher model after the teacher model is trained, a plurality of query and landing page pairs to determine, for each query and landing page pair, a query-to-document score; and storing, as a student model specificity training set, training tuples, each training tuple being a query and landing page pair and the query-to-document score determined for the query and landing page pair.

In another aspect, the method includes ensemble training, using the student model specificity training set and at least one other student model training set does not quantify the query-to-landing page specificity drift, a student model to predict a performance of a query for a landing page.

In another aspect, the ensemble training the student model comprises ensemble training a dual encoder.

In another aspect, the dual encoder comprises a query encoder that generate query embeddings from combined embeddings to two or more query dimensions; and a document encoder that generates document embeddings from combined embeddings of two or more document dimensions.

In another aspect, the teacher model comprises a cross-attention model comprising: transformer layers that receives as input combined embeddings from two or more query dimensions and two or more document embeddings for an input query and landing page pair; and pooler layer that the receives the output of the transformer layers and generates query-to-document scoring data for the input query and landing page pair.

In another aspect, the other student model training sets include information quality (IQ) labeled data and the landing page quality (LQ), and the ensemble training comprises: promoting a training loss for a sample when both the information quality (IQ) labeled data and the landing page quality (LQ) labeled data indicate scores that both exceed a respective high score threshold; and demoting a training loss for a sample when both the information quality (IQ) labeled data and the landing page quality (LQ) labeled data indicate scores that both do not meet a respective low score threshold.

In an aspect, determining, from the document-to-document scores, the query-to-document score that quantifies a query-to-landing page specificity drift comprises determining a central tendency value of the document-to-document scores determined for the query and landing page pair.

Another innovative aspect of the subject matter described in this specification can be embodied in methods that include the actions of: for each of a plurality of query and landing page pairs, each query and landing page pair being a particular query and a particular landing page selected for the query: obtaining, for the query, a proper subset of search results responsive to the query, the proper subset of search results being search results that are ranked higher than other search results in a set of search results determined to be responsive to the query, wherein each search result links to a search result page, for each search result page and the landing page: generating, by a large language model trained to determine a plurality of label probabilities, a plurality of label probabilities, each label probability generated for a particular label in a set of labels and the plurality of label probabilities generated by a single inference call of the large language model, determining, from the plurality of label probabilities, a document-to-document score that is a quantification of a specificity of the landing page relative to a specificity of the search result page, determining, from the document-to-document scores, a query-to-document score that quantifies a query-to-landing page specificity drift, and storing, as a teacher model specificity training set, training tuples, each training tuple being a query and landing page pair and the query-to-document score determined for the query and landing page pair; and training a teacher model on the teacher model training set to determine, for an input of a query and a landing page selected for the query, a query-to-document score, wherein the query-to-document score is determined without search results and search result pages determined to be responsive to the query. The features above can also be embodied in systems and non-transitory computer storage media.

These and other embodiments can each optionally include one or more of the following aspects. In an aspect, the large language model is an encoder-only model.

In another aspect, the method includes processing, using the teacher model after the teacher model is trained, a plurality of query and landing page pairs to determine, for each query and landing page pair, a query-to-document score; and storing, as a student model specificity training set, training tuples, each training tuple being a query and landing page pair and the query-to-document score determined for the query and landing page pair

In another aspect, the method includes ensemble training, using the student model specificity training set and at least one other student model training set does not quantify the query-to-landing page specificity drift, a student model to predict a performance of a query for a landing page.

In another aspect, ensemble training the student model comprises ensemble training a dual encoder.

In another aspect, dual encoder comprises: a query encoder that generate query embeddings from combined embeddings to two or more query dimensions; and a document encoder that generates document embeddings from combined embeddings of two or more document embeddings.

In another aspect, the query dimensions include knowledge graph entities and one or more of query text data, location data, and salient term terms data, and the document dimensions include knowledge graph entities and one or more of uniform resource locator data, salient term terms data, and document title data.

In another aspect, the other student model training sets include information quality (IQ) labeled data and the landing page quality (LQ), and the ensemble training comprises: promoting a training loss for a sample when both the information quality (IQ) labeled data and the landing page quality (LQ) labeled data indicate scores that both exceed a respective high score threshold; and demoting a training loss for a sample when both the information quality (IQ) labeled data and the landing page quality (LQ) labeled data indicate scores that both do not meet a respective low score threshold.

In another aspect, the teacher model comprises a cross-attention model comprising, transformer layers that receives as input combined embeddings from two or more query dimensions and two or more document embeddings for an input query and landing page pair; and a pooler layer that the receives the output of the transformer layers and generates query-to-document scoring data for the input query and landing page pair.

In another aspect, the query dimensions include knowledge graph entities and one or more of query text data, location data, and salient term terms data; and the document dimensions include knowledge graph entities and one or more of uniform resource locator data, salient term terms data, and document title data.

In another aspect, determining, rom the document-to-document scores, the query-to-document score that quantifies a query-to-landing page specificity drift comprises determining a central tendency value of the document-to-document scores determined for the query and landing page pair.

Particular embodiments of the subject matter described in this specification can be implemented so as to realize one or more of the following advantages. The training of the teacher model results in a teacher model that can generate a specificity labeled query-to-document scored student training set with much fewer resource requirements and a faster processing time than if a document-to-document large language model were used. This is because the document-to-document large language model individually predicts document-to-document specificity scores for document pairs, and these values are then used to generate the corresponding query-to-document specificity scores. The teacher model, on the other hand, predicts the query-to-document score based only on the landing page and query. Assuming M documents for every landing page are scored for specificity, and assuming that at least N specificity inferences are required for each landing page, the teacher model results in at least (N×M−M) fewer inferences than if the document-to-document large language model were used to generate the specificity labeled query-to-document scored student training set. Thus, when building training data sets, the systems and methods described herein realize a processing optimization that reduces both time to build the data set and reduces computer resources required to build the data set.

Moreover, because the teacher model does not require pages linked to by search results, search engine resources need not be utilized when building the larger training set. This bypasses the need for search processing, which frees up computer resources and system bandwidth.

In some implementations, the document-to-document large language model can be realized by an encoder only model, and the M document-to-document predictions can be determined from a single encoding process instead of M separate inferences. This results in decreased processing time required to generate the specificity labeled query-to-document scored teacher training set for training the teacher model.

The use of the teacher model, in turn, enables the practical generation of an extremely large specificity labeled query-to-document scored student training set. Such a large training set ensures that the resulting dual-encoder student model that predicts a performance of a query for a landing page is specificity aware. This awareness overcomes the inaccuracies of previous student models for which the ensemble training does not take into account the specificity drift of the query and the landing page.

In some implementations, the student model and the teacher model take into account knowledge graph entities of the query and landing page during training. Also, by taking into account the average number of entities present for a given query, and the average number of entities present for a given landing page, the feature length for the query entities and document entities can be selected to preclude training and inferences time degradation while still realizing improved overall performance. This results in a student model that is more robust in performance than a student model that does not take into account knowledge graph entities.

The overall work flow described in this specification is a staged workflow from which a teacher model that determines a query-to-document specificity score is trained from a training corpus generated from a labeled training corpus of document-to-document scores generated by a large language model. The teacher model is then used to generate an even larger corpus of specificity labeled query-to-document scored examples that are then used as part of an ensemble training of a student model. Each training stage in the workflow realizes a model that utilizes fewer processing resources to generate an output than would otherwise be required if its predecessor was used.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a large language model system is used in a training workflow that generates a student model that predicts a specificity-aware performance of a query for a landing page.

FIG. 2 is a diagram of a workflow for generating specificity aware models.

FIG. 3 is a diagram of a workflow for determining a document-to-document score for two documents.

FIG. 4 is a diagram of a workflow for determining a query-to-document score for a query and an associated landing page.

FIG. 5 is a flow diagram of an example process for training a teacher model that determines, for an input of a query and a landing page selected for the query, a query-to-document score that is, in part, specificity aware.

FIG. 6 is a flow diagram of an example process for training a student model that determines, for an input of a query and a landing page selected for the query, a query-to-document score, that is, in part, specificity aware.

FIG. 7 is an example architecture of a teacher model.

FIG. 8 is an example architecture of a student model.

FIG. 9 a block diagram of an example computer system.

Like reference numbers and designations in the various drawings indicate like elements.

### DETAILED DESCRIPTION

### Overview

The technology described in this written description relates to a large language model (LLM) that is used to generate a specificity labeled query-to-document scored teacher training set for training a teacher model. The teacher model is trained to take, as input, a query and landing page, and from this input generate a query-to-document score. This score is then used to label the query and landing page pair to generate a specificity label student training set. The student training set is then used in ensemble training of a student model to predict a performance of a query for a landing page.

As will be described below, the workflow and models are selected to reduce processing resources in a staged manner. Moreover, in some implementations, certain model architectures are selected to reduce overall inference times required for generating training sets. Each of these features, either alone or in combination, realizes significant savings in physical computer resource requirements and processing time.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

### Example Operating Environment

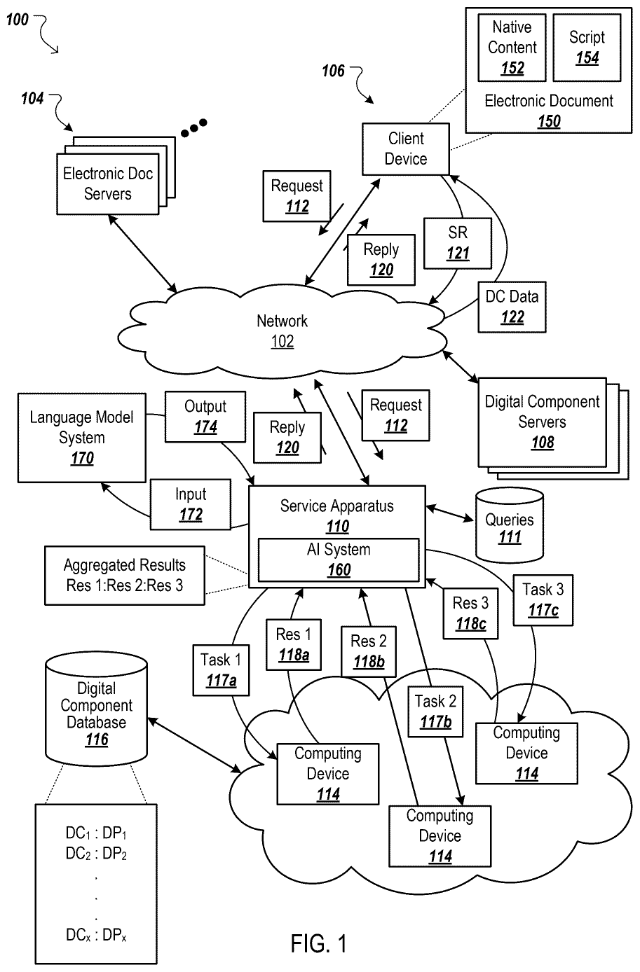

FIG. 1 is a block diagram of an example environment in which a large language model system 170 is used in a training workflow that generates a student model that predicts a specificity-aware performance of a query for a landing page. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords” or simply “keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page. Queries received by users of, for example, a search system, may be stored in a query storage 111.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

Performance of the keywords that result in placement of a digital component can be monitored. For example, data describing click rates, conversion rates, cost per clicks, and other data can be monitored for keywords associated with a digital component. A particular keyword may have multiple sets of performance data, with each set associated with a particular digital component or group of digital components for which the keyword is used for placement. For example, a first provider of digital components may have selected the keyword “hiking boots” for placement of a first set of digital components, and a second provider of digital components may have selected the keyword “hiking boots” for placement of a second set of digital components. The keyword “hiking boots” will thus have a first set of performance data for the first set of digital components, and a second set of performance data for the second set of digital components.

The service apparatus 110 can also include an artificial intelligence system 160 configured to generate data for the identification of digital components. As described in more detail throughout this specification, the artificial intelligence (“AI”) system 160 can generate digital component selection data (keywords) for digital components. These keywords are then used by providers of digital components as selection criteria for their digital components. A keyword may be a single word or term, or may be a combination of terms and numbers.

A large language model is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model system 170 can include any appropriate language model neural network that receives an input sequence made up of text tokens selected from a vocabulary and auto-regressively generates an output sequence made up of text tokens from the vocabulary. For example, the language model in the system 170 can be a Transformer-based language model neural network or a recurrent neural network-based language model.

In some situations, the large language model in the system 170 can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model system 170 can process the current input sequence to generate a score distribution, e.g., a probability distribution, that assigns a respective score, e.g., a respective probability, to each token in the vocabulary of tokens. The neural network of the language model system 170 can then select, as the particular token, a token from the vocabulary using the score distribution. For example, the neural network of the language model system 170 can greedily select the highest-scoring token or can sample, e.g., using nucleus sampling or another sampling technique, a token from the distribution.

As a particular example, the language model system 170 can include an auto-regressive Transformer-based neural network that includes (i) a plurality of attention blocks that each apply a self-attention operation and (ii) an output subnetwork that processes an output of the last attention block to generate the score distribution.

The large language model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners, arXiv preprint arXiv:2005.14165, 2020. Such example models include multitask unified model, a zero-shot model, a domain specific model, or a language representation model.

Generally, however, the transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same large language model in the system 170 to generate multiple different candidate output sequences in response to the same request, e.g., by using beam search decoding from score distributions generated by the language model, using a Sample-and-Rank decoding strategy, by using different random seeds for the pseudo-random number generator that's used in sampling for different runs through the language model or using another decoding strategy that leverages the auto-regressive nature of the language model.

In some implementations, the language model in the system 170 is pre-trained, i.e., trained on a language modeling task that does not require providing evidence in response to user questions, and the service apparatus 110 (e.g., using AI system 160) causes the language model in the system 170 to generate output sequences according to the pre-determined syntax through natural language prompts in the input sequence.

### Query and Landing Page Specificity

In some implementations, the system 170 uses the large language model in a workflow that is used to generate a student model to predict a performance of a query for a landing page. Once the student model is prepared and trained, the service apparatus 110 can provide, to the student model, a query and a landing page as input 172, and receive, as output 174, a score or series of scores, e.g., a vector, that predicts a performance of the query for the landing page.

As described above, incorporating a measure of query-landing page specificity drift can improve the overall performance of the student model. As will be described in the sections that follow, the system 170 implements a complex workflow that is used to generate a specificity aware student model in a manner the conserves physical computer resources and processing time.

With respect to query-to-landing page specificity, a query that is more specific than a landing page generally does not adversely impact performance of a query and landing page pair. Such performance may be, for example, satisfaction of information need, user engagement, or other measurable metrics that can be determined from traffic log analysis. As a query become more generic and a landing page becomes more specific relative to each other, however, the actual performance of the query for the landing page tends to degrade.

To illustrate, for the rather generic query “horse,” consider a landing page that is relatively specific for a fencing product, e.g., “Horse Fencing: Wooden and Electric.” While the query may score well for the landing page for a given relevance model, the landing page itself may not actually be a good match due to the high generic-to-specific specificity drift from the query to the landing page. This is because the subject matter of the page may be too specific for the query, and thus may not satisfy the user's informational need. Incorporating specificity awareness in the model can account for this relative difference in specificity.

Conversely, for the more specific query “non-slip rugs for kitchen and bathroom,” the landing page “Buy non-slip area rugs from ExtraStock” may be a good match, assuming, for example, the landing page has filtering options for kitchens and bathrooms. However, a given relevance model may not take into account the filtering options, and thus may predict the query to be less relevant to the landing page that it actually is. Once again, incorporating specificity awareness in a model account for this relative difference in specificity.

### Workflow for Building Specificity Aware Models

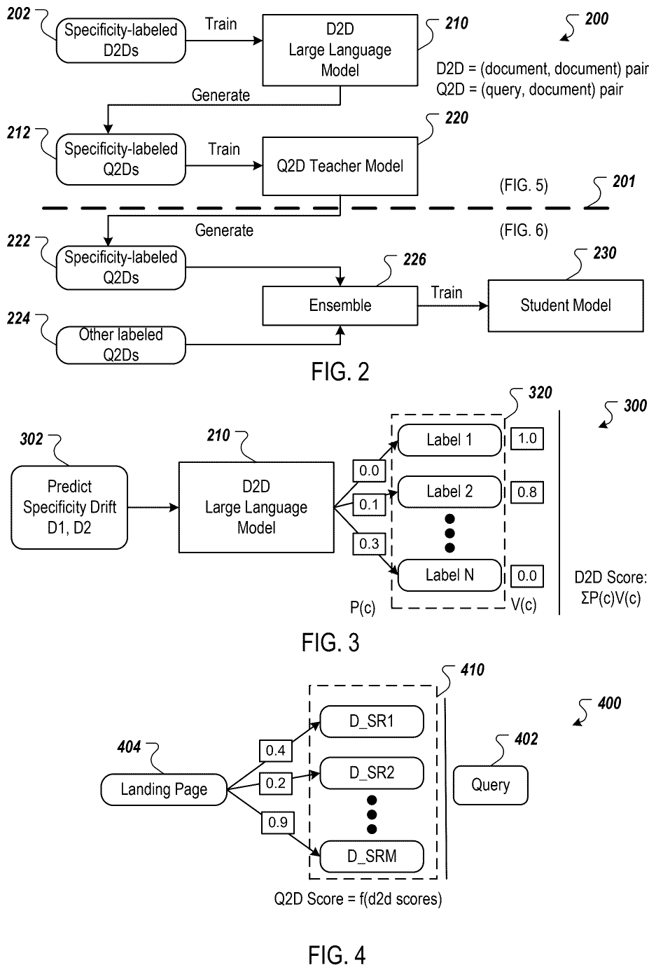

FIG. 2 is a diagram of a workflow 200 for generating specificity aware models. FIG. 2 is described with reference to FIGS. 3-6. In particular, FIG. 3 is a diagram of a workflow 300 for determining a document-to-document score for two documents, and FIG. 4 is a diagram of a workflow 400 for determining a query-to-document score for a query and an associated landing page.

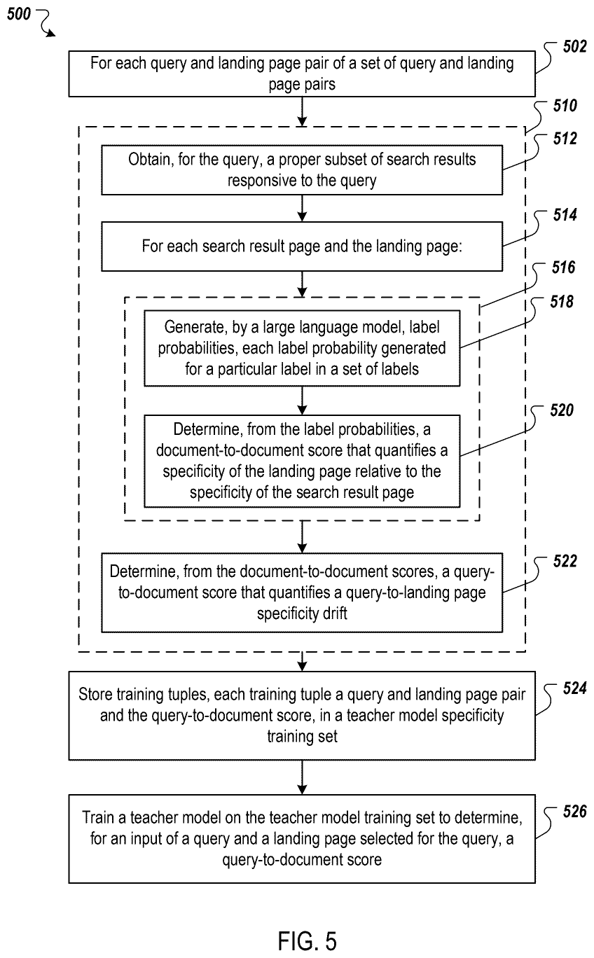

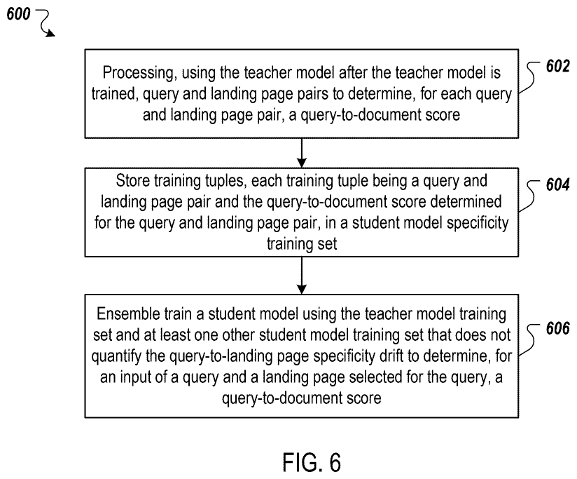

The particular portions of the workflow 200 above the dashed line 201 are described with reference to FIG. 5, which is a flow diagram of an example process 500 for training a teacher model that determines, for an input of a query and a landing page selected for the query, a query-to-document score that is, in part, specificity aware. Likewise, the particular portions of the workflow 200 below the dashed line 201 are described with reference to FIG. 6, which is a flow diagram of an example process 600 for training a student model that determines, for an input of a query and a landing page selected for the query, a query-to-document score that is, in part, specificity aware.

The workflow begins with a set of specificity labeled document-to-document pairs 202. The specificity labeled document-to-document pairs 202 constitute a training set for training a document-to-document large language model 210 that predicts document specificity drift from a first document, e.g., a landing page selected for a query, to a second document, e.g., a page referenced by a search result in response to the query. The specificity labeled document-to-document pairs 202 may be generated, for example, by human raters, and the labels can be selected to quantify a specificity drift from the landing page to the document. For example, assume a given left/right pair, with left being a landing page and right being a document referenced by a search result:
[Landing_Page]↔[Search_Result_Page]

A rater is tasked with labeling the pair with one of the following:
Different (−)
Left More Specific (−)
Right More Specific (+)
About The Same (+)

The first two labels have a negative value, and the last two labels have a positive value. Each document-to-document pair is labeled by N multiple raters. From the labels, the system determines a numerical value that quantifies the specificity drift from the landing page document to the search result document.

Any appropriate scoring methodology can be used. In one implementation, a majority vote method is used, where the score is given by the formula:

$$D 2 D\_score = 1 if ( num\_pos \geq num\_neg ) , else 0 ;$$

Where num_pos is the number of positive values, and num_neg is the number of negative values.

In another implementation, a cumulative difference is use, where the score is given by the formula:

$$D 2 D\_score = ( num\_pos - num\_neg ) / num\_total$$

Where num_total is the total number or labels.

In some implementations, the score range may be normalized to be in range of [0, 1].

Once the training set is generated, it is used to train the document-to-document large language model 210. The model 210 can be trained as described above. In some implementations, the document-to-document large language model 210 is trained to determine a probability for a set of N labels, where each label corresponds to a quantification of the document-to-document specificity drift. For example, as shown in FIG. 3, a set 320 of N descriptive labels are selected for the model 210 to predict. Each label in the set 320 corresponds to a specificity drift value V(c) in the given range of specificity drift. Once the document-to-document large language model 210 is trained, it then determines, for a given pair of documents 302, e.g., documents D1 and D2, a prediction value P(c) for each of the N labels. Each label prediction value P(c) is then multiplied by its respective label value, i.e., the specificity drift value V(c), and these products are then summed to obtain the overall document-to-document score for the document pair D1 and D2. For example, assume six labels Label 1 . . . . Label 6 have the respective label values 1.0, 0.8, 0.6, 0.4, 0.2 and 0.0, and for a given document pair D1 and D2 the model 210 generates the respective label predictions of 0.0, 0.1, 0.3, 0.2, 0.1, and 0.3. The overall document-to-document score is thus:

$$0. * 1. + 0.1 * 0.8 + 0.3 * 0.6 + 0.2 * 0.4 + 0.2 * 0.2 + 0.3 * 0. = 0.38$$

This final document-to-document score is a quantification of a specificity of a first document (e.g., a landing page for a query) relative to a specificity of a second document (e.g., a search result page of a search result responsive to the query). Other scoring formulas can also be used.

Once the document-to-document large language model 210 is trained, it is used to generate a training corpus of labeled query-to-document scores for query and document pairs. Each query-to-document score quantifies a query-to-landing page specificity drift. As shown in FIG. 4, the query-to-document score is determined for a given query 402 and landing page 404. To determine the query-to-document score for the query and landing page pair, the document-to-document scores are first calculated. Thus the document-to-document language model 210 receives, for each search result in a proper subset 410 of search results responsive to the query, data for a search result page linked to by the search result. The proper subset of search results is search results that are ranked higher than other search results in a set of search results determined to be responsive to the query. For example, in FIG. 4, the documents in the proper subset 410 may correspond to the top five highest ranked search results for the query 402.

For each of the search result pages in the proper subset 410, the document-to-document large language model 210 determines the document-to-document score for the landing page and the search result page. Once the document-to-document scores are determined, then the system 170 determines the final query-to-document score is determined based on the document-to-document scores. In some implementations, the query-to-document score is based on a central tendency value of the document-to-document scores. For example, assume in FIG. 4 the five document-to-document values determined for the landing page are 0.4, 0.2, 0.3, 0.8 and 0.9. If the central tendency is an average, then the query-to-document score for the query 402 and landing page 404 is 0.52. Other scoring formulas can also be used.

For a document pair of a landing page and a search result page, the input to the document-to-document large language model 210, in some implementations, is the title of the landing page and the title of the search result page. However, the document-to-document large language model 210 may be trained on other or additional input data as well.

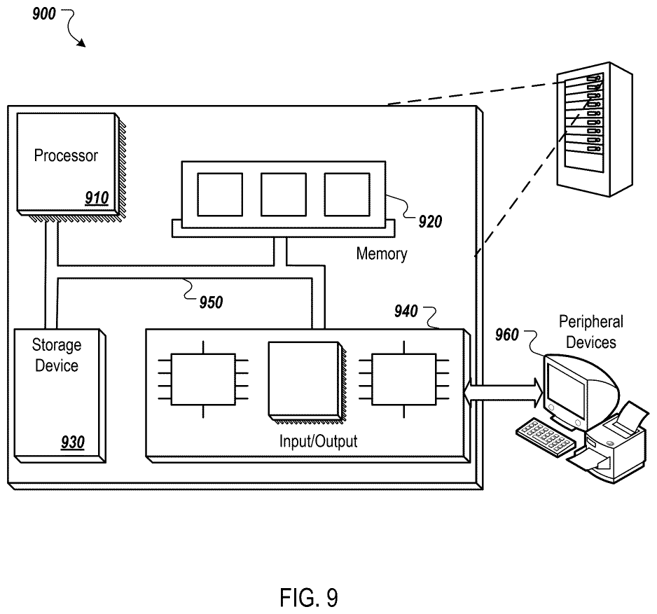

The end-to-end process of the workflow 200 is now described with reference to FIGS. 5 and 6. The processes 500 and 600 can be performed by data processing devices and memory storage systems in data communication with each other, such as the devices described with reference to FIG. 9 below.

The process 500 begins with the system, e.g., system 170, selecting a query and landing page pair (502), and then the system performs the processes described in the sub-block 510. The sub-block 510 is repeated for each query and landing page pair to generate the data necessary to build the specificity-labeled Q2Ds 222 that are used in the ensemble training of the teacher model 210.

For the query and landing page pair, the process 500 obtains, for the query, a proper subset of search results responsive to the query (512). The proper subset of search results are the search results that are ranked higher than other search results in a set of search results determined to be responsive to the query. Each search result links to a search result page. For example, the process 500 may submit the query 402 of FIG. 4 to a search engine, and receive the search results in response, and thus access the search result pages D_SR1-D_SRM.

The process 500 then proceeds by pairing each of the search results pages with the landing page (514) and performing the sub-block 516 for each pairing. In this way, the system 170 processes the M pairs on the landing page and search results pages D_SR1-D_SRM, i.e., (landing page 404, D_SR1), . . . (landing page 404, D_SRM).

For each search result page and landing page pair, the document-to-document large language model 210 generates label probabilities, where each label probability is generated for a particular label in a set of labels (518). For example, as depicted in FIG. 3, the document-to-document large language model 210 generates a respective prediction value for each of the labels Label 1 . . . . Label N.

The process 500 then determines, for the landing page and the search result page pair, and from the label probabilities, the document-to-document score that is a quantification of a specificity of the landing page relative to a specificity of the search result page, i.e., the specificity drift from the landing page to the search result page (520). The document-to-document score can be generated as described above with reference to FIG. 3.

After the document-to-document scores are determined for each of the search result and landing page pairs for a given landing page, the process then determines, from the document-to-document scores, a query-to-document score that quantifies a query-to-landing page specificity drift (522). For example, as shown in FIG. 4, for the M document-to-document scores of the search result pages 410, the query-to-document score is determined for the query 402 and landing page 404 pair. The query-to-document score can be generated as described above with reference to FIG. 4.

The process 500 then stores training tuples, where each training tuple is a query and landing page pair and the query-to-document score, in a teacher model specificity training set (524). In FIG. 2, the teacher model specificity training set is the specificity-labeled query document pairs 212. In some implementations, tens of millions of query-landing page pairs may be labeled for the training set 212.

The process 200 then trains the query-to-document teacher model 220 on the teacher model training set to determine, for an input of a query and a landing page selected for the query, a query-to-document score (526). Once trained, the teacher model 220 determines the query-to-document score without search results and search result pages determined to be responsive to the query. More specifically, the teacher model 200 receives data from the query and the landing page to determine the query-to-landing page score. Accordingly, the requesting of search results and the multiple inferences of the document-to-document large language model 210 are eliminated by use of the teacher model 220, which saves significant physical resources and reduces processing time.

The teacher model 220 is then used to generate a student model specificity training set 222, which is then used for ensemble training of a student model 230. This is described with reference to FIG. 6, which depicts an example process 600 for training a student model that determines, for an input of a query and a landing page selected for the query, a query-to-document score that is, in part, specificity aware.

The process 600 processes, using the teacher model 220 after the teacher model is trained, query and landing page pairs to determine, for each query and landing page pair, a query-to-document score (602). The teacher model 220 receives as input only the query and landing page pair, and does not require the fetching of search result responsive to the query or the determination of individual landing page to search result document scores. As a result, fewer computer resources and time are required to determine query-to-document specificity scores for a query and landing page pair.

The process 600 stores training tuples, each training tuple being a query and landing page pair and the query-to-document score determined for the query and landing page pair, in a student model specificity training set (604). In FIG. 2, the student model specificity training set is the specificity-labeled query document pairs 222. In some implementations, the training set 222 may include up to a billion or more labeled training pairs.

The process 600 ensemble trains a student model using the teacher model training set and at least one other student model training set that does not quantify the query-to-landing page specificity drift to determine, for an input of a query and a landing page selected for the query, a query-to-document score (606). The ensemble training may be done with other labeled query document data 224, such as click quality (CQ) labeled data for query to lading page pairs, information quality (IQ) labeled data for query to lading page pairs, and landing page quality (LQ) labeled data for query to lading page pairs. The click quality labeled data quantifies a click probability of a document provided in response to the query. The information quality quantifies an information satisfaction of a document for a query. The landing page quality quantifies a quality of measure of a landing page for a query. Other labeled data derived from traffic logs can also be used for ensemble training.

In some implementations, the ensemble training is done such that the specificity labeled data is weighted more when other labeled data are indeterminate as to the quality of the landing page and query pair performance. For example, for a given landing page and query pair, when both the information quality (IQ) labeled data and the landing page quality (LQ) labeled data indicate scores that both exceed a respective high score threshold (i.e., each respective score exceeds a respective “high” score threshold), the training loss for the sample is promoted. Conversely, for a given landing page and query pair, when both the information quality (IQ) labeled data and the landing page quality (LQ) labeled data indicate scores that both do not meet a respective low score threshold (e.g., each respective score is less than a respective “low” score threshold), the training loss for the sample is demoted.

If, however, nether condition described above is met, then the specificity labeled data are weighted to be most indicative of performance. Accordingly, the ensemble training results in a student model that is specificity aware and that relies more heavily on specificity when the combinations of information quality (IQ) and landing page quality (LQ) do not indicate either good or bad performance, i.e., when the combinations of the information quality (IQ) label and the landing page quality (LQ) label are possibly indeterminate as to a performance prediction.

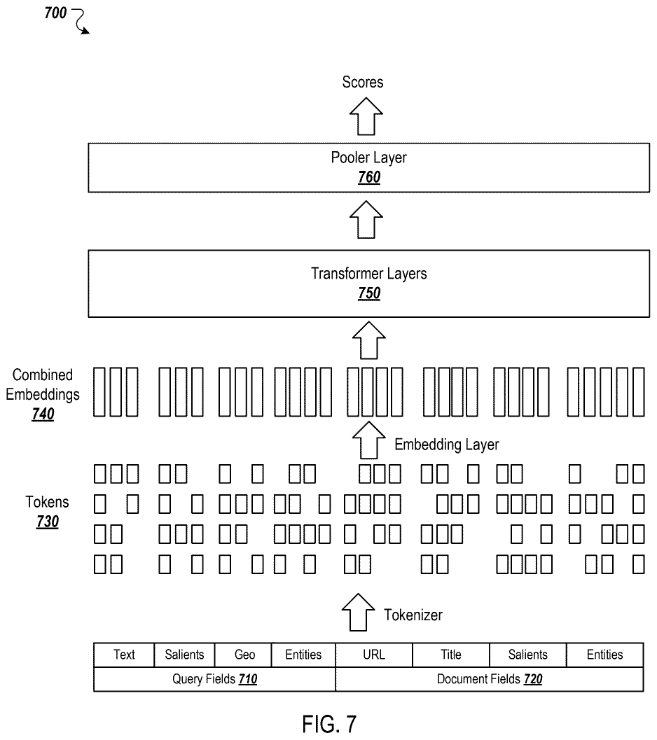

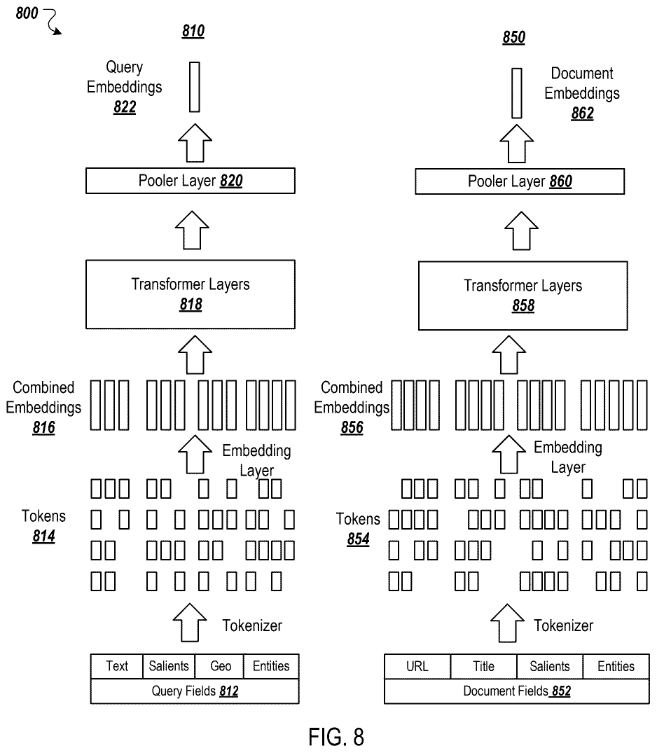

Once the student model 230 is trained, it can be used by the service apparatus 110, as described above. Additional details regarding the teacher model 220 are described with reference to FIG. 7 below, and additional details regarding the student model 230 are described with reference to FIG. 8 below.

### Model Architectures

As described above, the document-to-document large language model 220, utilizing a decoder, requires a separate inference for each label prediction when determining document-to-document scores. Accordingly, because M documents for every landing page are scored for specificity, and each document requires a prediction for N labels, the document-to-document large language model requires N×M inferences to determine a query-to-document score for each landing page.

In another implementation, the document-to-document large language model 220 is an encoder-only model. One example encoder-only architecture is the EncT5 encoder model. When an encode-only model is used, N separate inferences are not required to generate the respective N predictions for each label of labels 1−N. Instead, the label probabilities for the N labels are determined by a single call. Accordingly, processing time to produce the training set 212 can be reduced significantly. Moreover, because the decoding process steps are removed, the processing time to generate the predictions is further reduced. In operation, the output of the encoder includes logits for each of the label predictions, and the logits are processed directly to produce the entire set of label predictions in a single pass.

FIG. 7 is an example architecture of a teacher model 220. The teacher model 220, which can be, for example, a cross-attention model, is trained on one or more query dimensions and one or more document dimensions, e.g., fields 710 for the query and 720 for the documents. For example, the fields 710 include text, salient terms, geo location, and entities. The text field includes text of the query. The salient terms, which are terms derived from the query, are terms that are determined to be of topical importance. The geo location is the location specified in the query and/or the location from which the query was received. For the document fields 720, the URL field is the uniform resource locator of the document, and the title field includes the title text of the document. The salient terms are terms derived from the document and that are determined to be of topical importance.

The entities field for the query fields 710 and the document fields 720 are knowledge graph entities that are determined to be relevant to the query. A knowledge graph is a graph of entities in which each entity is represented by a node and edges between entities indicate that the entities are related. A knowledge graph typically represents network of real-world entities, such as objects, events, or concepts, and the relationships between the entities.

The service apparatus 110 can determine, for both the query and the document, entities based on analysis of the query text and the document text, the locations associated with the query and documents, and based on other data related to the query and document. For both the query and document, the system 100 determines the average number of entities determined for each, and considers percentile ranks of the number of entities determined. The system then selections a number of entity features for each of the query and document fields. In some implementations, the query entity features are selected as 8, and the document entity features are selected as 16. These value provide an acceptable trade-off between training and inferences time degradation and performance improvement.

The inputs are tokenized by a tokenizer to a sequence of tokens 730, e.g., input integers. An embedding layer then takes the tokens and generates combined embeddings 740 by mapping the tokens to embeddings. The tokenization is the arrangement of the input data into tokens that can be mapped into a vector space.

The transformer layers 750 receive the combined embeddings as input. The embeddings, as combined, are from two or more query dimensions and two or more document embeddings for an input query and landing page pair. The transformer layers 750 map the input sequence of embeddings to a sequence of continuous representations. The output of the transformer layers 750 is provided to the pooler layer 760, which, in turn, produces a vector representation of the input sequence. The generated vector is a representation of query-to-document scoring data for the input query and landing page pair.

FIG. 8 is an example architecture of a student model 230. In some implementations, the student model 230 is a dual encoder and includes a query encoder 810 and a document encoder 850. The query encoder 810 generates query embeddings from combined embeddings to two or more query dimensions, and the document encoder 850 generates document embeddings from combined embeddings of two or more document embeddings.

The student model 230 is ensemble trained on the one or more query dimensions and the one or more document dimensions, e.g., fields 812 for the query and 852 for the documents. For example, the fields 812 include text, salient terms, geo location, and entities. The text field includes text of the query. The salient terms are terms derived from the query and that that are determined to be of topical importance. The geo location is the location specified in the query and/or the location from which the query was received. For the document fields 852, the URL field is the uniform resource locator of the document, and the title field includes the title text of the document. The salient terms are terms derived from the document and that are determined to be of topical importance.

The inputs are tokenized by tokenizers to a sequence of tokens 814 and 854, respectively, e.g., input integers. Respective embedding layers then take the respective tokens 814 and 854 and generate respective combined embeddings 816 and 856 by mapping the respective tokens 814 and 854 to respective embeddings 816 and 856.

Respective transformer layers 818 and 858 receive the respective combined embeddings 818 and 858 as input and map the input sequence of embeddings to a sequence of continuous representations. The output of the respective transformer layers 818 and 858 are provided to the respective pooler layers 820 and 860, which respective query embeddings 822 and document embeddings 862. The query embeddings 822 and document embeddings 862 are used to predict a performance of an input query for an input landing page. For example, a cosine similarity score that measured the similarity of the query embeddings 822 to the document embedding 862 can be used to predict the score. Other appropriate scoring processes can also be used.

The models of FIGS. 7 and 8 can be trained on any set of query fields and document fields shown. For example, the models can be trained on any combination of the text, salient terms, geo location, URL, and entities fields. For example, the models can be trained only on the text, salient terms, geo location, and URL fields. Additionally, other fields that are now shown in FIGS. 7 and 8 can also be used for training.

### Additional Implementation Details

FIG. 9 is a block diagram of an example computer system 900 that can be used to perform operations described above. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, an optical disk device, a storage device that is shared over a network by multiple computing devices (e.g., a cloud storage device), or some other large capacity storage device.

The input/output device 940 provides input/output operations for the system 900. In one implementation, the input/output device 940 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 960. Other implementations, however, can also be used, such as mobile computing devices, mobile communication devices, set-top box television client devices, etc.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
for each of a plurality of query and landing page pairs, each query and landing page pair being a particular query and a particular landing page selected for the query:
obtaining, for the query, a proper subset of search results responsive to the query, the proper subset of search results being search results that are ranked higher than other search results in a set of search results determined to be responsive to the query, wherein each search result links to a search result page;
for each search result page and the landing page:
generating, by a large language model trained to determine a plurality of label probabilities, a plurality of label probabilities, each label probability generated for a particular label in a set of labels and the plurality of label probabilities generated by a single inference call of the large language model;
determining, from the plurality of label probabilities, a document-to-document score that is a quantification of a specificity of the landing page relative to a specificity of the search result page;
determining, from the document-to-document scores, a query-to-document score that quantifies a query-to-landing page specificity drift; and
storing, as a teacher model specificity training set, training tuples, each training tuple being a query and landing page pair and the query-to-document score determined for the query and landing page pair; and
training a teacher model on the teacher model training set to determine, for an input of a query and a landing page selected for the query, a query-to-document score, wherein the query-to-document score is determined without search results and search result pages determined to be responsive to the query.

2. The method of claim 1, wherein the large language model is an encoder-only model.

3. The method of claim 2, further comprising:
processing, using the teacher model after the teacher model is trained, a plurality of query and landing page pairs to determine, for each query and landing page pair, a query-to-document score; and
storing, as a student model specificity training set, training tuples, each training tuple being a query and landing page pair and the query-to-document score determined for the query and landing page pair.

4. The method of claim 3, further comprising:
ensemble training, using the student model specificity training set and at least one other student model training set does not quantify the query-to-landing page specificity drift, a student model to predict a performance of a query for a landing page.

5. The method of claim 4, wherein ensemble training the student model comprises ensemble training a dual encoder.

6. The method of claim 5, wherein the dual encoder comprises:
a query encoder that generate query embeddings from combined embeddings to two or more query dimensions; and
a document encoder that generates document embeddings from combined embeddings of two or more document embeddings.

7. The method of claim 6, wherein:
the query dimensions include knowledge graph entities and one or more of query text data, location data, and salient term terms data;
the document dimensions include knowledge graph entities and one or more of uniform resource locator data, salient term terms data, and document title data.

8. The method of claim 4, where the other student model training sets include information quality (IQ) labeled data and the landing page quality (LQ), and the ensemble training comprises:
promoting a training loss for a sample when both the information quality (IQ) labeled data and the landing page quality (LQ) labeled data indicate scores that both exceed a respective high score threshold; and
demoting a training loss for a sample when both the information quality (IQ) labeled data and the landing page quality (LQ) labeled data indicate scores that both do not meet a respective low score threshold.

9. The method of claim 3, wherein the teacher model comprises a cross-attention model comprising:
transformer layers that receives as input combined embeddings from two or more query dimensions and two or more document embeddings for an input query and landing page pair; and
a pooler layer that the receives the output of the transformer layers and generates query-to-document scoring data for the input query and landing page pair.

10. The method of claim 9, wherein:
the query dimensions include knowledge graph entities and one or more of query text data, location data, and salient term terms data;
the document dimensions include knowledge graph entities and one or more of uniform resource locator data, salient term terms data, and document title data.

11. The method of claim 1, wherein determining, from the document-to-document scores, the query-to-document score that quantifies a query-to-landing page specificity drift comprises determining a central tendency value of the document-to-document scores determined for the query and landing page pair.

12. A system, comprising:
one or more computers in data communication; and
one or more non-transitory computer readable medium storing instructions executable by the one or more computers that when executed by the one or more computers cause the one or more computers to perform operations comprising:
for each of a plurality of query and landing page pairs, each query and landing page pair being a particular query and a particular landing page selected for the query:
obtaining, for the query, a proper subset of search results responsive to the query, the proper subset of search results being search results that are ranked higher than other search results in a set of search results determined to be responsive to the query, wherein each search result links to a search result page;
for each search result page and the landing page:
generating, by a large language model trained to determine a plurality of label probabilities, a plurality of label probabilities, each label probability generated for a particular label in a set of labels and the plurality of label probabilities generated by a single inference call of the large language model;
determining, from the plurality of label probabilities, a document-to-document score that is a quantification of a specificity of the landing page relative to a specificity of the search result page;
determining, from the document-to-document scores, a query-to-document score that quantifies a query-to-landing page specificity drift; and
storing, as a teacher model specificity training set, training tuples, each training tuple being a query and landing page pair and the query-to-document score determined for the query and landing page pair; and
training a teacher model on the teacher model training set to determine, for an input of a query and a landing page selected for the query, a query-to-document score, wherein the query-to-document score is determined without search results and search result pages determined to be responsive to the query.

13. The system of claim 12, wherein the large language model is an encoder-only model.

14. The system of claim 13, the operations further comprising:
processing, using the teacher model after the teacher model is trained, a plurality of query and landing page pairs to determine, for each query and landing page pair, a query-to-document score; and
storing, as a student model specificity training set, training tuples, each training tuple being a query and landing page pair and the query-to-document score determined for the query and landing page pair.

15. The system of claim 14, wherein the student model is a dual encoder, and the operations further comprise:
ensemble training, using the student model specificity training set and at least one other student model training set does not quantify the query-to-landing page specificity drift, a student model to predict a performance of a query for a landing page.

16. The system of claim 15, wherein the dual encoder comprises:
a query encoder that generate query embeddings from combined embeddings to two or more query dimensions; and
a document encoder that generates document embeddings from combined embeddings of two or more document embeddings.

17. The system of claim 16, wherein:
the query dimensions include knowledge graph entities and one or more of query text data, location data, and salient term terms data;
the document dimensions include knowledge graph entities and one or more of uniform resource locator data, salient term terms data, and document title data.

18. The system of claim 15, where the other student model training sets include information quality (IQ) labeled data and the landing page quality (LQ), and the ensemble training comprises:
promoting a training loss for a sample when both the information quality (IQ) labeled data and the landing page quality (LQ) labeled data indicate scores that both exceed a respective high score threshold; and
demoting a training loss for a sample when both the information quality (IQ) labeled data and the landing page quality (LQ) labeled data indicate scores that both do not meet a respective low score threshold.

19. One or more non-transitory computer readable medium storing instructions, that when executed by an artificial intelligence system, causes the artificial intelligence system to perform operations comprising:
obtaining, for the query, a proper subset of search results responsive to the query, the proper subset of search results being search results that are ranked higher than other search results in a set of search results determined to be responsive to the query, wherein each search result links to a search result page;
for each search result page and the landing page:
generating, by a large language model trained to determine a plurality of label probabilities, a plurality of label probabilities, each label probability generated for a particular label in a set of labels and the plurality of label probabilities generated by a single inference call of the large language model;
determining, from the plurality of label probabilities, a document-to-document score that is a quantification of a specificity of the landing page relative to a specificity of the search result page;
determining, from the document-to-document scores, a query-to-document score that quantifies a query-to-landing page specificity drift; and
storing, as a teacher model specificity training set, training tuples, each training tuple being a query and landing page pair and the query-to-document score determined for the query and landing page pair; and
training a teacher model on the teacher model training set to determine, for an input of a query and a landing page selected for the query, a query-to-document score, wherein the query-to-document score is determined without search results and search result pages determined to be responsive to the query.
